(19) United States
(12) Patent Application Publication
(10) Pub. No.: US 2026/0195677 A1
(43) Pub. Date: Jul. 9, 2026

(54) CLEANING MANAGEMENT DEVICE, CLEANING MANAGEMENT METHOD, AND RECORDING MEDIUM

(71) Applicant: NEC Corporation, Tokyo (JP)

(72) Inventors: Yoji Tabuchi, Tokyo (JP); Yasufumi Hirakawa, Tokyo (JP); Yusuke Takahashi, Tokyo (JP)

(73) Assignee: NEC Corporation, Tokyo (JP)

(21) Appl. No.: 19/003,266

(22) Filed: Dec. 27, 2024

(30) Foreign Application Priority Data
Mar. 5, 2024 (JP) 2024-032642

(51) Int. Cl. G06Q 10/0631; G06F 3/14; G06F 3/147

(52) U.S. Cl. CPC G06Q 10/06315; G06F 3/1423; G06F 3/147

(57) ABSTRACT

In a cleaning management device, a prediction means predicts a cumulative number of users for each restroom provided in a facility based on actual data and outputs a prediction cumulative number of users. A determination means determines a cleaning timing of each restroom based on the prediction cumulative number of users.

### TECHNICAL FIELD

This disclosure relates to a restroom cleaning management.

### BACKGROUND ART

A restroom installed in a facility is cleaned regularly. Patent Document 1 a method for determining an order in which a plurality of toilets are to be cleaned, in consideration of a state of a use of the plurality of toilets in the restroom.
Patent Document 1: Japanese Patent Application Laid-Open under No. 2020-86736

### SUMMARY

Patent Document 1 improves efficiency of cleaning of a restroom by determining an order of cleaning in consideration of a state of use of the restroom. However, in order to clean the restroom efficiently, it is necessary to accurately determine a condition that necessitates cleaning in the first place and determine a timing of cleaning.

One object of the present disclosure is to provide a cleaning management method that can accurately determine a state in which the restroom needs to be cleaned and enable cleaning to be carried out efficiently.

According to an example aspect of the present invention, there is provided a cleaning management device including:
at least one memory configured to store instructions; and
at least one processor configured to execute the instructions to:
predict a cumulative number of users for each restroom provided in a facility based on actual data and output a prediction cumulative number of users; and
determine a cleaning timing of each restroom based on the prediction cumulative number of users.

According to another example aspect of the present invention, there is provided a cleaning management method performed by a computer, the cleaning management method including:
predicting a cumulative number of users for each restroom provided in a facility based on actual data and outputting a prediction cumulative number of users; and
determining a cleaning timing of each restroom based on the prediction cumulative number of users.

According to still another example aspect of the present invention, there is provided a recording medium recording a program, the program causing a computer to execute processing of:
predicting a cumulative number of users for each restroom provided in a facility based on actual data and outputting a prediction cumulative number of users; and
determining a cleaning timing of each restroom based on the prediction cumulative number of users.

According to a further example aspect of the present disclosure, there is provided a cleaning management device including:
an evaluation acquisition means configured to acquire evaluations of users concerning a state of a restroom provided in a facility; and
a determination means configured to determine a cleaning timing of the restroom based on the evaluations of the users.

According to a still further example aspect of the present disclosure, there is provided a cleaning management method performed by a computer, the cleaning management method including:
acquiring evaluations of users concerning a state of a restroom provided in a facility; and
determining a cleaning timing of the restroom based on the evaluations of the users.

According to a yet still another example aspect of the present disclosure, there is provided a program causing a computer to execute processing of:
acquiring evaluations of users concerning a state of a restroom provided in a facility; and
determining a cleaning timing of the restroom based on the evaluations of the users.

### Effect

According to the present disclosure, it is possible to provide a cleaning management method which can accurately determine a state in which a restroom needs to be cleaned and enable cleaning to be carried out efficiently.

### BRIEF DESCRIPTION OF THE DRAWINGS

FIG. 1 is a block diagram showing an overall configuration of a cleaning management system.

FIG. 2 is a block diagram showing a hardware configuration of the cleaning management device.

FIG. 3 is a block diagram showing a functional configuration of the cleaning management device.

FIG. 4 illustrates an example of a work time table.

FIG. 5 illustrates an example of a restroom utilization rate table.

FIG. 6 is a diagram for explaining a method of determining the cleaning timing.

FIG. 7 is a flowchart of the cleaning plan creation process according to a first example embodiment.

FIG. 8 is a diagram illustrating a method of determining a cleaning timing using satisfaction level data,

FIG. 9 is a flowchart of a cleaning plan creation process according to a second example embodiment.

FIG. 10 is a diagram illustrating a method of determining a cleaning timing using an integration score.

FIG. 11 is a flowchart of a cleaning plan creation process according to a third example embodiment.

FIG. 12 is a block diagram showing a functional configuration of a cleaning management device of a fourth example embodiment.

FIG. 13 is a flowchart of a process by a cleaning management device of the fourth example embodiment.

FIG. 14 is a block diagram illustrating a functional configuration of a cleaning management device according to a fifth example embodiment.

FIG. 15 is a flowchart of a process by the cleaning management device of the fifth example embodiment.

### EXAMPLE EMBODIMENTS

Preferred example embodiments of the present disclosure will be described with reference to the accompanying drawings. In the following example embodiments, it is assumed that a method of the present disclosure is applied to a cleaning management of each of restrooms provided in an airport.

### First Example Embodiment

### Overall Configuration

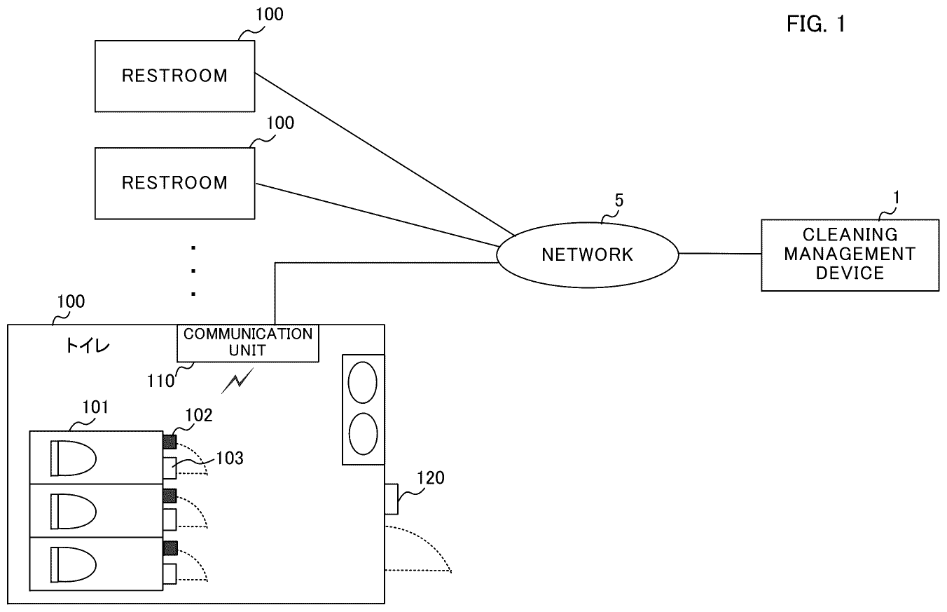

FIG. 1 is a block diagram showing an overall configuration of a cleaning management system to which a cleaning management device according to the present disclosure is applied. The cleaning management system includes a cleaning management device 1 for managing a cleaning of a plurality of restrooms provided in the airport. The cleaning management device 1 is communicatively connected to a plurality of restrooms 100 via a network 5. In this specification, the term “restroom” is intended to refer to a restroom facility at a single place which includes a plurality of private stalls and respective toilets therein, and is distinguished from the private stalls.

Each restroom 100 includes one or more private stalls 101. Each private stall 101 is provided with a restroom sensor 102 for detecting a state of use of the private stall by the user, that is, for detecting whether or not each private stall is in use. The restroom sensor 102 may be, for instance, a detection sensor for opening and closing a door of a single private stall, may be a human sensor for detecting a presence or absence of a user in a single private stall, or may be another type of a sensor. Note that in the example in FIG. 1, the restroom 100 is a female restroom with only a single stall, but the present example embodiment is also applicable to a male restroom with male urinals.

Each restroom 100 includes a communication unit 110. The communication unit 110 communicates with the restroom sensor 102 provided in the private stall 101 by wired or wireless communication. The communication unit 110 can communicate with the cleaning management device 1 through the network 5. Specifically, the communication unit 110 transmits usage status information of each private stall by the user which is detected by the restroom sensor 102, to the cleaning management device 1.

Moreover, for each restroom 100, a display panel 120 is provided near an entrance to the restroom. The display panel 120 displays various information to the user. The display panel 120 can communicate with the communication unit 110 by wired or wireless. The communication unit 110 transmits the information sent from the cleaning management device 1 to the display panel 120 for display. The display panel 120 may be configured using a touch panel to enable the user to provide some input to the display panel 120.

Furthermore, a display board 103 is provided to each of the private stalls 101. The display board 103 displays information concerning each private stall 101. The display panel 103 may be, for instance, a liquid crystal panel etc. on the outside of the door of the private room 101. Each display board 103 can also communicate with the cleaning management unit 1 via the communication unit 110 and the network 5.

### [Hardware Configuration]

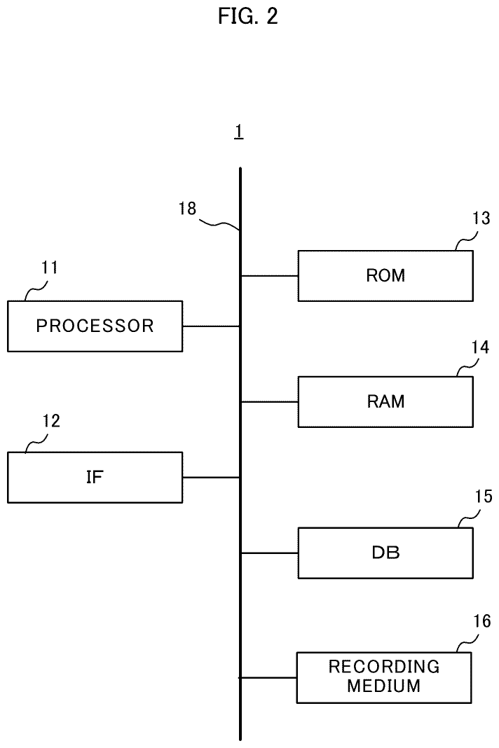

FIG. 2 is a block diagram showing a hardware configuration of the cleaning management device 1. As shown, the cleaning management device 1 includes a processor 11, an interface (IF) 12, a ROM (Read Only Memory) 13, a RAM (Random Access Memory) 14, a data base (DB) 15, and a recording medium 16. These components are mutually connected to each other, for instance, through a bus 18.

The processor 11 is a computer such as a CPU (Central Processing Unit) and controls the entire cleaning management device 1 by executing a program prepared in advance. Specifically, the processor 11 may be a CPU, GPU (Graphics Processing Unit), a DSP (Digital Signal Processor, a MPU (Micro Processing Unit), a FPU (Floating Point number Processing Unit), a PPU (Physics Processing Unit), a TPU (Tensor Processing Unit), a quantum processor, a microcontroller, or a combination thereof.

The processor 11 loads the program stored in ROM 13 or the recording medium 16 to the RAM 14 and executes the processes coded in the program. The processor 11 functions as part or all of the cleaning management device 1. The processor 11 executes the cleaning plan generation process to be described later.

The IF 12 transmits and receives data to and from each external device. Specifically, the cleaning management device 1 receives, through the IF 12, use state information transmitted from the communication unit 110 of the restroom 100. Also, the IF 12 outputs the information to be displayed on the display panel 120 of the restroom 100 to the communication unit 110 of the restroom 100.

The ROM 13 stores various programs executed by the processor 11. The RAM 14 is used as a working memory during various processes performed by the processor 11.

The DB 15 stores various algorithms, data, a machine learning model, etc. which are used in a case where the cleaning management device 1 executes a cleaning plan generation process which will be described later. In addition, the DB 15 may store actual data of actual use state information, that is, a history of the use state information detected by each of restroom sensors 102 of the restroom 100 in a predetermined period of the past.

The recording medium 16 is a non-volatile and non-transitory recording medium such as a disc-shaped recording medium, a semiconductor memory, etc. The recording medium 16 may be detachably configured with respect to the cleaning management device 1. The recording medium 16 records various programs executed by the processor 11.

In addition to the above, the cleaning management device 1 may include a display device such as a liquid crystal display, and an input device such as a keyboard or a mouse. These display devices and the input device are used, for instance, by an operator of the cleaning management device 1.

### [Functional Configuration]

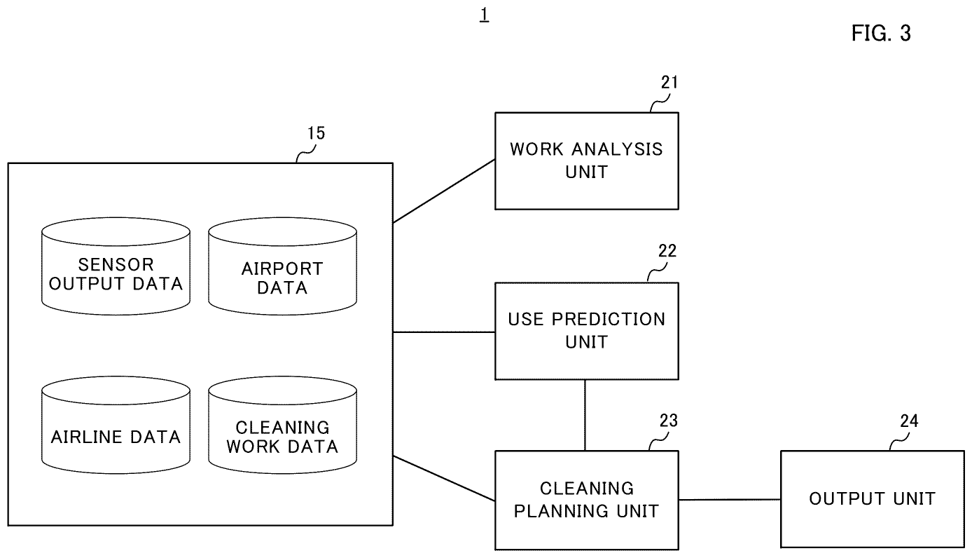

FIG. 3 is a block diagram showing a functional configuration of the cleaning management device 1. The cleaning management device 1 functionally includes a work analysis unit 21, a use prediction unit 22, a cleaning planning unit 23, and an output unit 24, in addition to the DB 15 described above.

The DB 15 stores sensor output data, airport data, airline data, and cleaning work data. Specifically, the sensor output data are output data of each restroom sensor 102 provided for each private stall 101 of the restroom 100, that is, the use state information of each private stall 101 every hour.

The airport data includes location information of each of the restrooms 100 in the airport, the location information of all boarding gates, the maximum available number (number of private stalls) for each restroom, the passage number of security gates in the airport, etc. The airline data includes operation time information (arrival and departure information) for each aircraft. Specifically, the operation time information includes an arrival time and a departure time of each aircraft, a number of passengers on board, a destination, a boarding gate number, etc.

The cleaning work data are historical data of the cleaning work for each restroom by cleaning staff. Specifically, the cleaning work data includes the past cleaning history of each restroom, the time taken for cleaning work, the work time (work start time, work end time), etc.

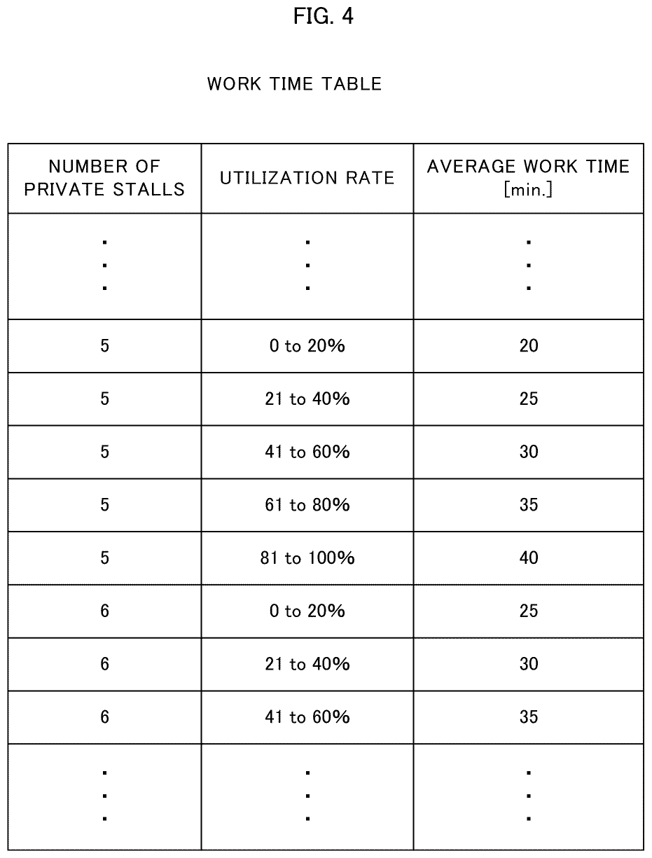

The work analysis unit 21 creates a work time table using the cleaning work data. FIG. 4 shows an example of the work time table. As shown in FIG. 4, the work time table shows an average work time in relation to the number of private stalls and a utilization rate. Here, an item of “number of private stalls” indicates the number of private stalls 101 included in the restroom 100. An item of “utilization rate” indicates a utilization rate of the private stalls included in restrooms 100. For instance, in a restroom with five private stalls, if the utilization rate indicates 21 to 40%, the average work time will be 25 minutes. It is possible for the cleaning management device 1 to plan for efficient cleaning by a limited number of cleaning staff, referring to the work time table and obtaining the average work time according to the number of private stalls and the utilization rate of the restroom 100.

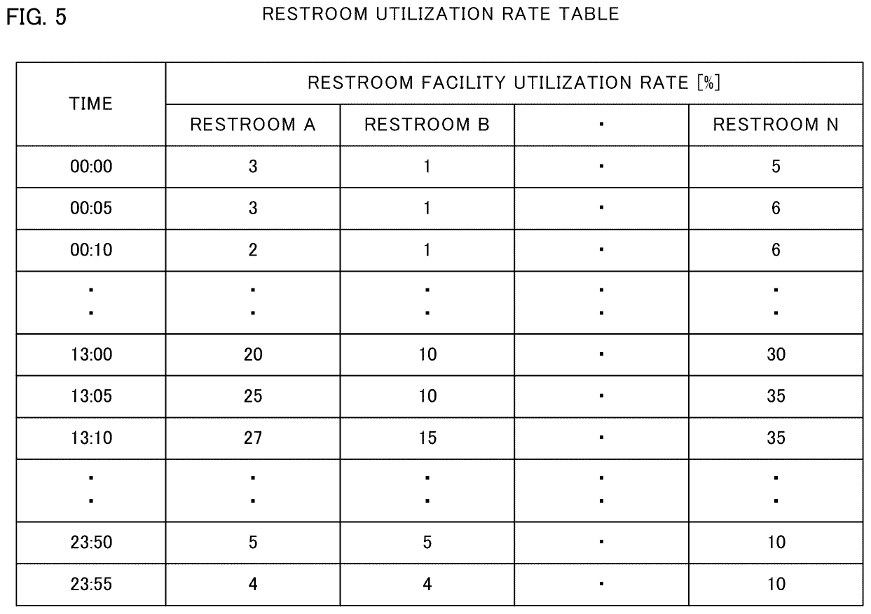

Based on the sensor output data, the airport data, and the airline data, the use prediction unit 22 calculates a prediction value of a cumulative number of users for each restroom 100 (hereinafter, referred to as a “prediction cumulative number of users”). The use prediction unit 22 first creates a restroom utilization rate table by totaling the number of users of each restroom 100 for each hour of the day in the past based on the sensor output data and by calculating the utilization rate of each restroom for each hour of the day. FG. 5 illustrates an example of the restroom utilization rate table. The restroom utilization rate table shows the utilization rate of each restroom 100 for each hour of the day. In the example in FIG. 5, the restroom utilization rate table shows the utilization rate every five minutes for each of the restrooms 100 provided in the airport.

Next, the use prediction unit 22 predicts the number of persons using each of the restrooms 100 in the future by using the restroom utilization rate table, and outputs the prediction cumulative number of users at a future date and time. Specifically, the use prediction unit 22 predicts the number of users in each time zone (for instance, every hour) of a next day using the restroom utilization rate table of the past few days, and calculates the prediction cumulative number of users at each time of the next day by adding the number of users in each time zone. For instance, in a case of using the restroom utilization rate for the last 10 days, the use prediction unit 22 predicts the prediction cumulative number of users at each time on October 11 using the restroom utilization rate from October 1 to October 10.

The use prediction unit 22 considers the airport data in a case of calculating the prediction cumulative number of users. For instance, the use prediction unit 22 calculates the prediction cumulative number of users of each restroom 100 by collecting the number of persons in each time zone, which is calculated based on the restroom utilization rate table, based on a distance between adjacent restrooms in the airport, a distance between each restroom and a boarding gate, a distance between each gate and a security checkpoint, and a maximum available number of each restroom, etc.

In addition, the use prediction unit 22 considers the airline data in a case of calculating the prediction cumulative number of users. For instance, the use prediction unit 22 calculates the prediction cumulative number of users in each restroom 100 by collecting the number of people in use in each time zone calculated based on the restroom utilization rate table, based on the arrival and departure times of the aircraft, the number of passengers boarding the aircraft, etc. After that, the use prediction unit 22 outputs the prediction cumulative number of users in a predetermined period in the future (e.g., the next day), to the cleaning planning unit 23.

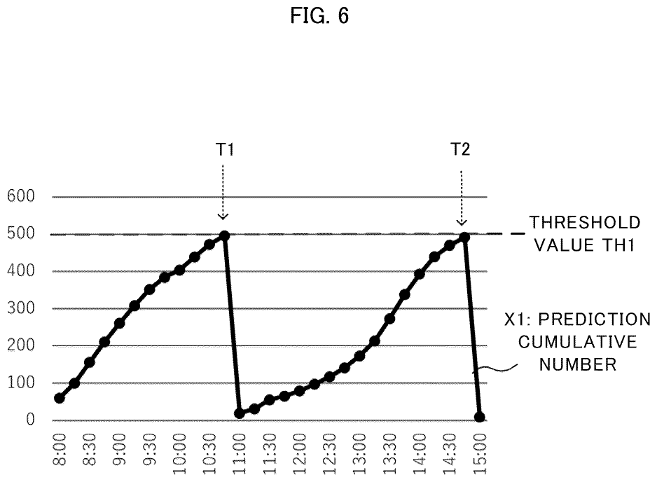

The cleaning planning unit 23 determines a cleaning timing of each restroom 100 based on the prediction cumulative number of users. This is basically based on an idea that as the cumulative number of restroom users increases, the restroom becomes dirty and needs cleaning. Specifically, the cleaning planning unit 23 determines a timing of that the prediction cumulative number of users reaches a predetermined threshold value TH1, as the cleaning timing. FIG. 6 is a diagram for explaining a method of determining the cleaning timing. In FIG. 6, a horizontal axis indicates the time, a vertical axis indicates the number of people, and a graph indicates a prediction cumulative number X1 of users. As shown in FIG. 6, the predicted cumulative population X1 is increased over time. In the example in FIG. 6, the threshold value TH1 is set to 500 users, and in a case where the predicted cumulative population X1 of users reaches the threshold value TH1, the cleaning planning unit 23 determines a time T1 as the cleaning time. Next, the cleaning planning unit 23 resets the prediction cumulative number X1 of users at the determined cleaning timing. In the example of FIG. 6, the predicted cumulative population X1 is reset in the time T1. After that, in a case where the prediction cumulative number X1 of users is increased and the prediction cumulative number X1 of users reaches the threshold value TH1 again in a time T2, the cleaning planning unit 23 determines the time T2 as the cleaning timing. Accordingly, whenever the prediction cumulative number X1 of people reaches the threshold value TH1, i.e. whenever the cumulative number of users of each restroom reaches 500, the cleaning planning unit 23 determines that the cleaning timing has reached.

Next, the cleaning planning unit 23 creates a cleaning plan based on the determined cleaning timing and the work time table shown in FIG. 4. The cleaning plan refers to a cleaning schedule for each restroom by the cleaning staff. For instance, suppose that the cleaning timing for a certain restroom A is determined to be 13:00. In addition, the restroom A is assumed to include five private stalls. In this case, the cleaning planning unit 23 acquires a utilization ratio of “20%” at 13:00 for the restroom A by referring to the restroom utilization ratio table shown in FIG. 5. Next, the cleaning planning unit 23 acquires an average work time “20 minutes” by referring to the work time table based on the number of private stalls (five private stalls) and the obtained utilization rate (20%) for the restroom A, and sets the cleaning time of the restroom A to be 13:00 to 13:20. Accordingly, the cleaning planning unit 23 sets the cleaning time of each restroom by acquiring the average work time for each cleaning timing determined, and creates a cleaning plan.

### [Cleaning Plan Creation Process]

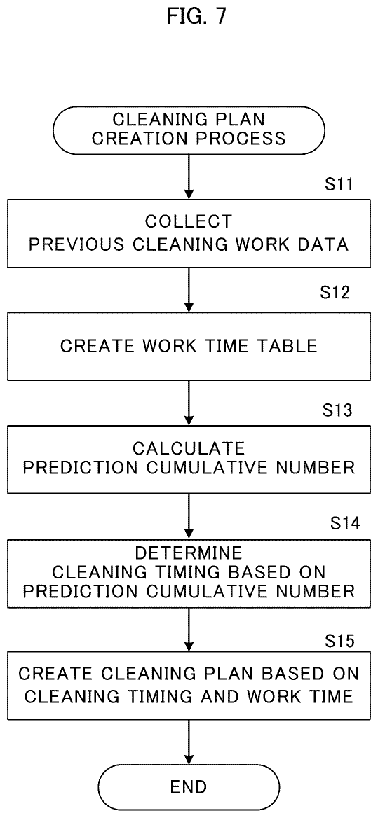

Next, a cleaning plan creation process will be described. FIG. 7 is a flowchart of the cleaning plan creation process according to a first example embodiment. As described above, the cleaning plan creation process is a process in which the cleaning management device 1 is a process of creating the cleaning plan for each restroom. This cleaning plan creation process is realized by the processor 11 shown in FIG. 2 which executes programs prepared in advance and operates as respective elements shown in FIG. 3.

First, the work analysis unit 21 collects previous cleaning work data (step S11), and creates a work time table as illustrated in FIG. 4 (step S12). Next, the use prediction unit 22 calculates the prediction cumulative number of users by using the sensor output data, the airport data, the airline data, etc. in the past (step S13).

Next, the cleaning planning unit 23 determines the cleaning timing based on the prediction cumulative number of users (step S14). Specifically, the cleaning planning unit 23 determines a timing at which the prediction cumulative number X1 of users reaches the threshold value TH1 as shown in FG. 6, as the cleaning timing. Next, the cleaning planning unit 23 creates a cleaning plan based on the determined cleaning timing and the work time table (step S15). After that, the cleaning plan creation process is terminated.

As described above, in the first example embodiment, since the prediction cumulative number of users of each restroom is calculated using the sensor output data indicating past use of the restroom, airport data, airline data and other data, and the cleaning time for each restroom is determined, it is possible to efficiently determine the cleaning timing of each restroom. In addition, since the prediction cumulative number of users is calculated by considering a positional relationship between each restroom and the boarding gate, etc., and a flight timetable information, it becomes possible to precisely set cleaning timings and plan for cleaning, in consideration of characteristics of a facility (airport in this example) where restrooms are installed and to make a cleaning plan.

### Second Example Embodiment

In the first example embodiment, the cleaning management device 1 determines the cleaning timing based on the prediction cumulative number of users of each restroom. In contrast, in a second example embodiment, the cleaning management device 1 determines the cleaning timing based on evaluation information of the user regarding a state of the restroom.

### [Overall Configuration]

In the second example embodiment, the overall configuration of the cleaning management system is basically the same as the overall configuration shown in FIG. 1. However, in the second example embodiment, the user of the restroom is asked to vote an evaluation with respect to a cleaning state of the restroom. For instance, in FIG. 1, a display panel 120 provided near the entrance of each restroom 100 is constituted by a touch panel, so that when the user comes out of the restroom, the user is requested to input a satisfaction degree regarding the cleaning state of the restroom to the user.

The cleaning management device 1 periodically acquires a satisfaction level input by the user from the display panel 120 via the communication unit 110 and the network 5. Accordingly, for each restroom 100, it is possible for the cleaning management device 1 to collect satisfaction level data of the user for the cleaning state. The satisfaction level data collected are accumulated in the DB 15 shown in FIG. 3.

### [Hardware Configuration]

In the second example embodiment, a hardware configuration of the cleaning management device 1 is the same as the hardware configuration of the first example embodiment shown in FIG. 2.

### [Functional Configuration]

In the second example embodiment, a functional configuration of the cleaning managemnent device 1 is basically the same as the functional configuration of the first example embodiment shown in FIG. 3. However, in the second example embodiment, the cleaning planning unit 23 determines the cleaning timing of each restroom 100 based on the collected satisfaction level data.

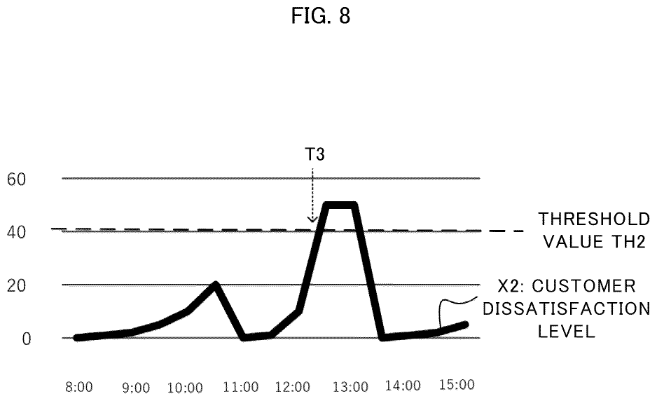

FIG. 8 is a diagram illustrating a method of determining the cleaning timing using the satisfaction level data. The cleaning planning unit 23 generates a customer dissatisfaction level X2 shown in FIG. 8 based on the satisfaction level data. Next, the cleaning planning unit 23 determines a time when the customer dissatisfaction level X2 reaches a predetermined threshold value TH2, as the cleaning timing of the restroom. In the example of FIG. 8, the customer dissatisfaction level X2 has reached the threshold value TH2 in a time T3. Therefore, the cleaning planning unit 23 determines the time T2 as the cleaning timing. In the example of FIG. 8, the time T3 is determined as the cleaning timing, the customer dissatisfaction level X2 falls to around zero in a case where the cleaning is subsequently carried out. In the example of FIG. 8, the cleaning planning unit 23 determines the cleaning timing using the customer dissatisfaction level X2, but alternatively, the customer satisfaction level may be used to determine the cleaning timing. That is, the cleaning planning unit 23 may determine a time when the customer satisfaction level is lower than the predetermined threshold value TH2, as the cleaning timing.

### [Cleaning Plan Creation Process]

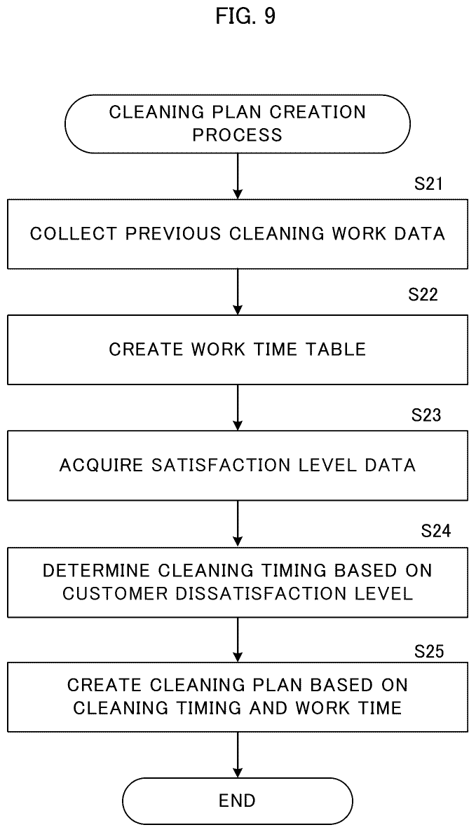

FIG. 9 is a flowchart of a cleaning plan creation process according to the second example embodiment. This process is realized by the processor 11 shown in FIG. 2 which executes a program prepared in advance and operates as a corresponding element shown in FIG. 3.

In the cleaning plan creation process according to the second example embodiment, since steps S21 and S22 are the same as steps S11 and S12 of the cleaning plan creation process of the first example embodiment shown in FIG. 7, the description thereof will be omitted.

In step S23, the cleaning planning unit 23 of the cleaning management device 1 acquires the satisfaction level data regarding the cleaning state of the restroom from the DB 15 (step S23). Next, the cleaning planning unit 23 calculates the customer dissatisfaction level X2 using the satisfaction level data, and determines the cleaning timing using the customer dissatisfaction level X2 (step S24). After that, the cleaning planning unit 23 creates a cleaning plan based on the determined cleaning timing and the work time table (step S25). Then, the cleaning plan creation process is terminated.

As described above, according to the second example embodiment, since the cleaning timing of the restroom is determined based on evaluations by users who actually use the restroom, it is possible to perform the cleaning in a state where the user considers that cleaning is actually necessary. Especially, by using the evaluations by the users, it becomes possible to quickly carry out the cleaning even in the case where the restroom is dirty for the sudden reason.

### Third Example Embodiment

In the first example embodiment, the cleaning management device 1 determines the cleaning timing based on the prediction cumulative number of users in each restroom. In the second example embodiment, the cleaning management device 1 determines the cleaning timing based on the evaluation s of the users with respect to the state of the restroom. In contrast, in a third example embodiment, the cleaning management device 1 determines the cleaning timing using both the prediction cumulative number of users for each restroom and the evaluations of users regarding the state of the restroom.

### [Overall Configuration]

In the third example embodiment, the overall configuration of the cleaning management system is basically the same as the overall configuration shown in FIG. 1. However, in the third example embodiment, similarly to the second example embodiment, the user of the restroom is asked to vote the evaluation of the cleaning state of the restroom. For instance, the user is asked to input the evaluation for the cleanliness of the restroom using the display panel 120 shown in FIG. 1 when they come out of the restroom.

### [Hardware Configuration]

In the third example embodiment, a hardware configuration of the cleaning management device 1 is the same as the hardware configuration of the first example embodiment shown in FIG. 2.

### [Functional Configuration]

In the third example embodiment, a functional configuration of the cleaning management device 1 is basically the same as the functional configuration of the first example embodiment shown in FIG. 3. However, in the third example embodiment, the cleaning planning unit 23 determines the cleaning timing of each restroom 100 using the prediction cumulative number of users calculated by the use prediction unit 22 and the satisfaction level data. Specifically, assuming that the prediction cumulative number of users calculated by the use prediction unit 22 is indicated by X1 and the customer dissatisfaction level obtained by voting by the user is indicated X2, the cleaning planning unit 23 calculates an integration score X3 in which the prediction cumulative number of users and the customer dissatisfaction level are combined according to the following formula (1).

$$Integrated score : X 3 = α X 1 + ( 1 - α ) X 2 \qquad ( 1 )$$

Here, “α” denotes a weight indicating which of the prediction cumulative number of users and the customer dissatisfaction level is emphasized in a case of determining the cleaning timing. Incidentally, the weight c may use different values for the male restroom and the female restroom, taking into account differences in perception between males and females. Moreover, adjustments may be made based on cultural and perceptual differences of each country, depending on factors such as the destination country of the aircraft.

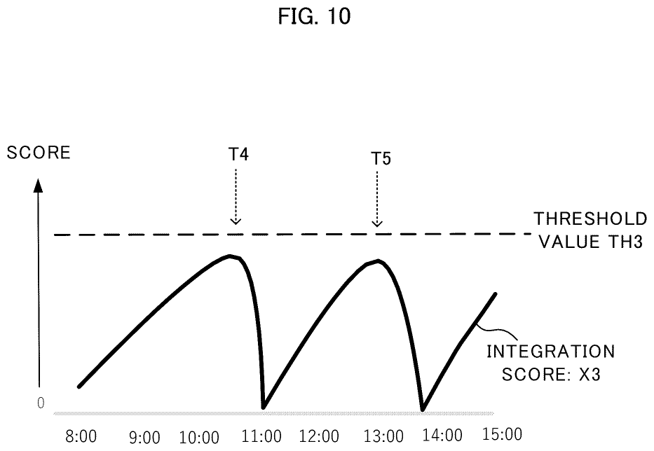

FIG. 10 is a diagram illustrating a method of determining the cleaning timing using the integration score. The cleaning planning unit 23 calculates the integration score X3 using the formula (1) described above, and determines a time when the integration score X3 reaches a predetermined threshold value TH3, as the cleaning timing of the restroom. In the example of FIG. 10, since the integration score X3 reaches the threshold value TH3 at a time T4, the cleaning planning unit 23 determines the time T4 as the cleaning timing. In the example of FIG. 10, the time T4 is determined as the cleaning timing, and the integration score X3 falls to around zero in a case where the cleaning is subsequently carried out. After that, the cleaning planning unit 23 determines a time T5 as a next cleaning timing as the integration score X3 reaches the threshold value TH3 again at the time T5.

### [Cleaning Plan Creation Process]

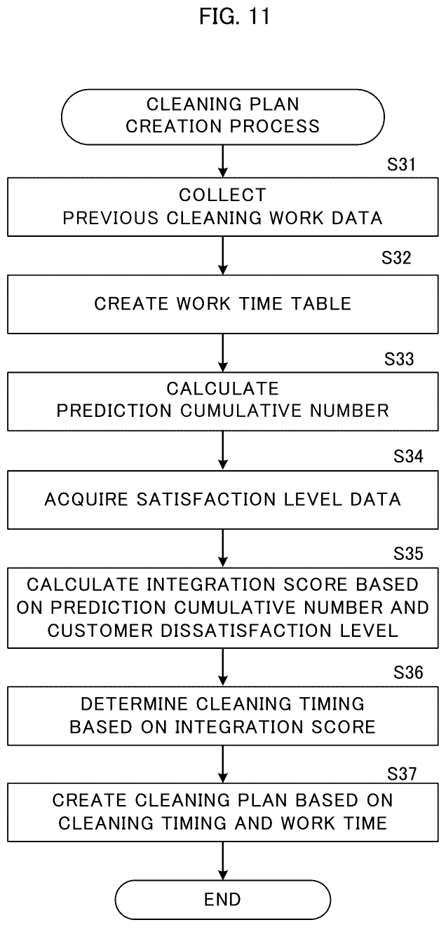

FIG. 11 is a flowchart of a cleaning plan creation process according to the third example embodiment. This cleaning plan creation process is realized by the processor 11 shown in FIG. 2 which executes a corresponding program prepared in advance and operates as an element shown in FIG. 3.

In the cleaning plan creation process according to the third example embodiment, since steps S31 to S33 are the same as steps S11 to S13 of the cleaning plan creation process of the first example embodiment shown in FIG. 7, the description thereof will be omitted.

In step S33, the cleaning planning unit 23 of the cleaning management device 1 acquires the satisfaction level data concerning the cleaning state of the restroom from the DB 15 (step S34). Next, the cleaning planning unit 23 calculates the customer dissatisfaction level X2 using the satisfaction level data, and calculates the integration score X3 by the formula (1) using the prediction cumulative number X1 of users and the customer dissatisfaction level X2 (step S35). Then, the cleaning planning unit 23 determines the cleaning timing using the integration score X3 (step S36). Thereafter, the cleaning planning unit 23 creates a cleaning plan based on the determined cleaning timing and the work time table (step S37). Accordingly, the cleaning plan creation process is terminated.

As described above, according to the third example embodiment, by determining the cleaning timing of the restroom based on both the prediction cumulative number of users of the restroom and the evaluation by the user who actually uses the restroom, it is possible to perform the cleaning at the precise timing from both viewpoints.

### Modifications

Next, modifications of the above example embodiment will be described. The following modifications may be applied to the above example embodiment in appropriate combination.

### Modification 1

The number of users of the restrooms in the airport is affected by the arrival time and the departure time of the aircraft. Usually, restrooms near departure and arrival gates tend to be crowded during a crowding period before the departure time of each departing flight (for instance, 30 to 5 minutes before the departure time; hereinafter referred to as a “pre-departure crowding period”) and a crowding period after the arrival time of each arriving flight (for instance, 20 minutes after arrival time; hereinafter referred to as a “post-arrival crowding period”).

Therefore, as one method, the cleaning management system 1 ensures that the cleaning timing is set before the pre-departure crowding period for the restroom near each departure gate of the departing flights. Also, the cleaning management device 1 ensures that the cleaning timing is set after the post-arrival crowding period for the restroom near each arrival gate of the arriving flights.

Specifically, the use prediction unit 22, which calculates the prediction cumulative number of users, multiplies the prediction cumulative number X1 of users by a weight factor β (1<β) during a first predetermined period before the pre-departure crowding period, thereby increasing the prediction cumulative number X1 of users. This accelerates an arrival of the cleaning timing, and makes it more likely for the cleaning timing to occur before the pre-departure crowding period. Also, in a second predetermined period after the post-arrival crowding period, the use prediction unit 22 multiplies the prediction cumulative number X1 of users by the weight factor β (1<β) to increase the prediction cumulative number X1 of users, and ensures that the cleaning timing arrives promptly after the post-arrival crowding period is lapsed.

Moreover, as another method, the cleaning management device 1 may set the cleaning timing by excluding the pre-departure crowding period and the post-arrival crowding period. Accordingly, it is possible to avoid the cleaning during the crowding period. Specifically, the cleaning planning unit 23 may set the cleaning timings after the pre-departure crowding period is lapsed and after the post-arrival crowding period is lapsed, in a case where one or more of the prediction cumulative number X1 of users, the customer dissatisfaction level X2, and the integration score X3 reaches respective threshold values within the pre-departure crowding period and the post-arrival crowding period.

### Modification 2

In the first to third example embodiments described above, the cleaning management device 1 manages the cleaning timing for each the restroom 100 including a plurality of private stalls 101. Instead, the cleaning management device 1 may manage the cleaning timing for each of the private stalls 101. Specifically, the cleaning management device 1 may calculate the prediction cumulative number X1 of users, the customer dissatisfaction level X2, or the integration score X3 for each of the private stalls 101, compare these calculated values with their respective threshold values, and set the cleaning timing for each of the private stalls 101, so that each private stall 101 is cleaned.

Moreover, in a case of managing the cleaning for each private stall 101, the cleaning management device 1 may be to present information of the private stalls for the user to use. Specifically, the cleaning management device 1 displays a high recommendation degree on the display board 103 of each private stall 101 immediately after the cleaning is completed, and as the time from the completion of cleaning has elapsed, the recommendation degree to be displayed is reduced. Accordingly, it is possible to distribute the use of the private stalls 101 among users. In this case, the cleaning management device 1 may use the network 5 and the communication unit 110 of each restroom 100 to display the recommendation degree on the display panel 103 of the private stall 101 to be a target.

Moreover, for the private stall 101 for which cleaning timing has arrived, the cleaning management device 1 may encourage users to use other private stalls by displaying a use restriction message, such as ‘Not Available’ or ‘Reserved for Cleaning,’ on the display board 103. In this case, the cleaning management device 1 may uses the network 5 and the communication unit 110 of the restroom 100, and display the use restriction message such as ‘Not Available’ on the display board 103 of the target private stall 101.

Incidentally, the cleaning management device 1 may display the above recommendation and use restriction message along with information specifying the target private stall 101 on the display panel 120 near an entrance/exit of the restroom 100.

### Modification 3

In the above example embodiment, odor of the restroom may be used to determine the cleaning timing. For instance, an odor sensor is provided at a predetermined location or the private stalls 101 in the restroom 100 to detect a level of odor (offensive odor) and transmits the detected level to the cleaning management device 1. The cleaning management device 1 may additionally schedule the cleaning at a time when the level of odor exceeds a predetermined threshold value, in addition to the determination method of the cleaning timing of the first to third example embodiments. Alternatively, the cleaning management device 1 may calculate the integration score in which the level of odor is combined with one or more of the prediction cumulative number of users and the customer dissatisfaction level, and determine the cleaning timing based on the calculated integration score.

### Modified Example 4

Although the above embodiment refers to the airport as an example of a facility with restrooms, the application of the present disclosure is not limited thereto. For instance, the cleaning management device described above can be applied to the restrooms installed at a station, a bus terminal, a terminal of a ship, etc. as a facility of public transportation such as a bullet train or a long-distance train, a long-distance bus, or a ship.

### Fourth Example Embodiment

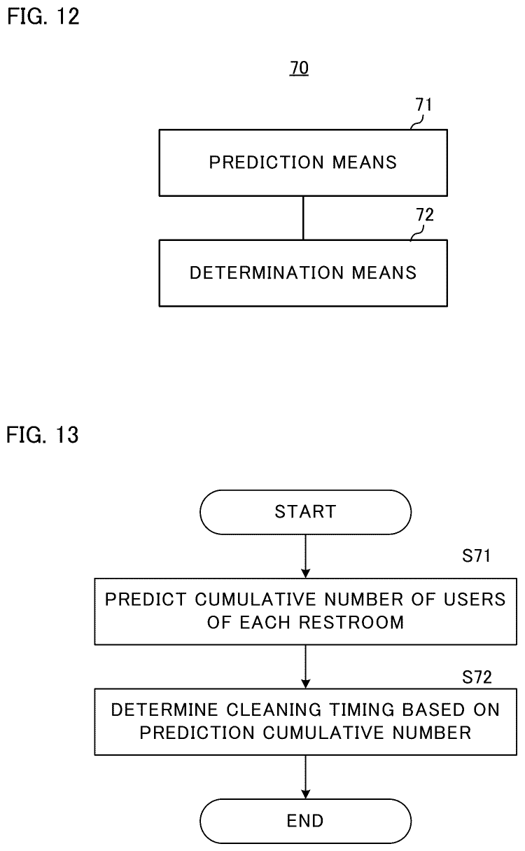

FIG. 12 is a block diagram showing a functional configuration of a cleaning management device of a fourth example embodiment. A cleaning management device 70 of the fourth example embodiment includes a prediction unit 71 and a determination unit 72.

FIG. 13 is a flowchart of a process by the cleaning management device 70 of the fourth example embodiment. The prediction unit 71 predicts the cumulative number of users of each restroom provided in a facility based on actual data, and outputs the prediction cumulative number of users (step S71). The determination unit 72 determines the cleaning timing of the restroom based on the prediction cumulative number of users (step S72). According to the cleaning management device 70 of the fourth example embodiment, it is possible to accurately determine a state where the cleaning of the restroom is necessary and to provide a cleaning management method capable of performing the cleaning efficiently.

### Fifth Example Embodiment

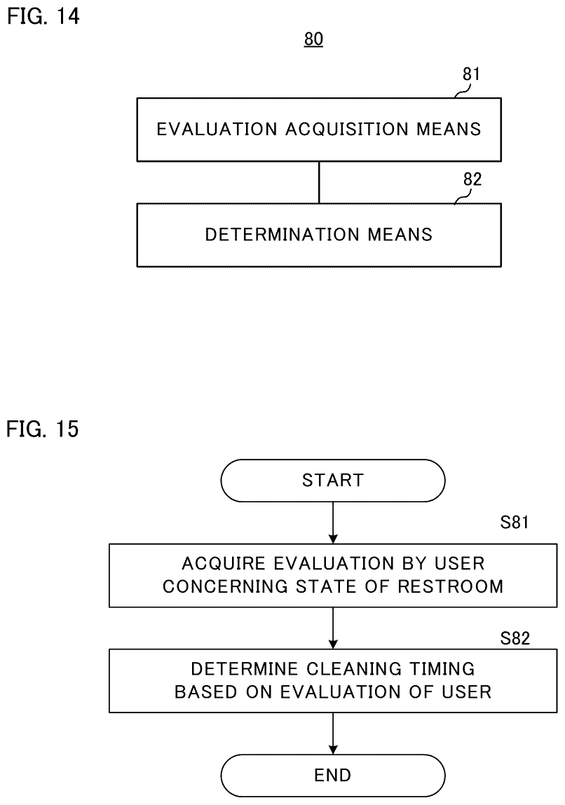

FIG. 14 is a block diagram illustrating a functional configuration of a cleaning management device according to a fifth example embodiment. A cleaning management device 80 of the fifth example embodiment includes an evaluation acquisition unit 81, and a determination unit 82.

FIG. 15 is a flowchart of a process by the cleaning management device 80 of the fifth example embodiment. The evaluation acquiring unit 81 acquires the evaluation of the user with respect to the state of each restroom provided in the facility (step S81). The determination unit 82 determines the cleaning timing of the restroom based on the evaluation of the user (step S82). According to the cleaning management device 80 of the fifth example embodiment, it is possible to accurately determine the state needs the cleaning of each restroom, to provide the cleaning management method capable of performing the cleaning efficiently.

A part or all of the example embodiments described above may also be described as the following supplementary notes, but not limited thereto.

### Supplementary Note 1

1. A cleaning management device comprising:
a prediction means configured to predict a cumulative number of users for each restroom provided in a facility based on actual data and output a prediction cumulative number of users; and
a determination means configured to determine a cleaning timing of each restroom based on the prediction cumulative number of users.

### Supplementary Note 2

2. The cleaning management device according to supplementary note 1, wherein
the facility is a facility for a public transportation; and
the prediction means calculates the prediction cumulative number of users based on timetable information of the public transportation.

### Supplementary Note 3

3. The cleaning management device according to supplementary note 2, wherein the prediction means increases a first prediction cumulative number of users in a first period before a crowding period after a departure of the public transportation and a second prediction cumulative number of users in a second period after a crowding period after an arrival of the public transportation more than the prediction cumulative number of users in a period other than the first period and the second period.

### Supplementary Note 4

4. The cleaning management device according to supplementary note 2 or 3, wherein the prediction means sets the cleaning timing within a period excluding a crowding period before an arrival of the public transportation and a crowding period after a departure of the public transportation.

### Supplementary Note 5

5. The cleaning management device according to any one of supplementary notes 1 to 4, wherein
the facility is a facility for a public transportation, and
the prediction means calculates the prediction cumulative number based on location information of each restroom in the facility.

### Supplementary Note 6

6. The cleaning management device according to any one of supplementary notes 1 to 5, wherein
the prediction means outputs the prediction cumulative number of users for each private stall in each restroom, and
the determination means determines the cleaning timing for each stall.

### Supplementary Note 7

7. The cleaning management device according to supplementary note 6, further comprising:
a display board provided in each stall in each restroom; and
a display control means configured to display information indicating that the private stall is unavailable, at the cleaning timing of the private stall.

### Supplementary Note 8

8. The cleaning management device according to supplementary note 6 or 7, further comprising:
a display board provided in each private stall in the restroom; and
a display control means configured to display a recommendation degree for using the private stall based on a time elapsed since a most recent cleaning time of the private stall.

### Supplementary Note 9

9. The cleaning management device according to any one of supplementary notes 1 to 5, further comprising an evaluation acquisition means configured to acquire evaluations by the users concerning a state of the restroom, wherein
the determination means determines the cleaning timing based on the evaluations by the users.

### Supplementary Note 10

10. The cleaning management device according to any one of supplementary notes 1 to 5, further comprising a sensor output acquisition means configured to acquire an output of a sensor concerning odor of the restroom,
wherein the determination means determines the cleaning timing based on the output of the sensor.

### Supplementary Note 11

11. A cleaning management method performed by a computer, the cleaning management method comprising:
predicting a cumulative number of users for each restroom provided in a facility based on actual data and outputting a prediction cumulative number of users; and
determining a cleaning timing of each restroom based on the prediction cumulative number of users.

### Supplementary Note 12

12. A program causing a computer to execute processing of:
predicting a cumulative number of users for each restroom provided in a facility based on actual data and outputting a prediction cumulative number of users; and
determining a cleaning timing of each restroom based on the prediction cumulative number of users.

### Supplementary Note 13

13. A cleaning management device comprising:
an evaluation acquisition means configured to acquire evaluations of users concerning a state of a restroom provided in a facility; and
a determination means configured to determine a cleaning timing of the restroom based on the evaluations of the users.

### Supplementary Note 14

14. A cleaning management method performed by a computer, the cleaning management method comprising:
acquiring evaluations of users concerning a state of a restroom provided in a facility; and
determining a cleaning timing of the restroom based on the evaluations of the users.

### Supplementary Note 15

15. A program causing a computer to execute processing of:
acquiring evaluations of users concerning a state of a restroom provided in a facility; and
determining a cleaning timing of the restroom based on the evaluations of the users.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2024-032642, filed on Mar. 5, 2024, the disclosure of which is incorporated herein in its entirety by reference.

### DESCRIPTION OF SYMBOLS

11 Processor
15 Database (DB)
21 Work analysis unit
22 Use prediction unit
23 Cleaning planning unit
24 Output unit
1, 70, 80 Cleaning management device

1. A cleaning management device comprising:
at least one memory configured to store instructions; and
at least one processor configured to execute the instructions to:
predict a cumulative number of users for each restroom provided in a facility based on actual data and output a prediction cumulative number of users;
determine a cleaning timing of each restroom based on the prediction cumulative number of users;
referring to a work time table that includes an average work time in relation to a number of private stalls and utilization rate; and
setting, for each restroom, the average work time according to the number of private stalls and the utilization rate of the restroom.

2. The cleaning management device according to claim 1, wherein
the facility is a facility for a public transportation; and
the processor calculates the prediction cumulative number of users based on timetable information of the public transportation.

3. The cleaning management device according to claim 2, wherein the processor increases a first prediction cumulative number of users in a first period before a crowding period after a departure of the public transportation and a second prediction cumulative number of users in a second period after a crowding period after an arrival of the public transportation more than the prediction cumulative number of users in a period other than the first period and the second period.

4. The cleaning management device according to claim 2, wherein the processor sets the cleaning timing within a period excluding a crowding period before an arrival of the public transportation and a crowding period after a departure of the public transportation.

5. The cleaning management device according to claim 1, wherein the processor
outputs the prediction cumulative number of users for each private stall in each restroom, and
determines the cleaning timing for each stall.

6. The cleaning management device according to claim 5, further comprising a display board provided in each stall in each restroom,
wherein the processor displays information indicating that the private stall is unavailable, at the cleaning timing of the private stall.

7. The cleaning management device according to claim 5, further comprising: a display board provided in each private stall in the restroom; and
wherein the processor displays a recommendation degree for using the private stall based on a time elapsed since a most recent cleaning time of the private stall.

8. The cleaning management device according to claim 1, wherein the processor
acquires evaluations by the users concerning a state of the restroom, and
determines the cleaning timing based on the evaluations by the users.

9. A cleaning management method performed by a computer, the cleaning management method comprising:
predicting a cumulative number of users for each restroom provided in a facility based on actual data and outputting a prediction cumulative number of users;
determining a cleaning timing of each restroom based on the prediction cumulative number of users;
referring to a work time table that includes an average work time in relation to a number of private stalls and utilization rate; and
setting, for each restroom, the average work time according to the number of private stalls and the utilization rate of the restroom.

10. A non-transitory computer-readable recording medium storing a program causing a computer to execute processing of:
predicting a cumulative number of users for each restroom provided in a facility based on actual data and outputting a prediction cumulative number of users;
determining a cleaning timing of each restroom based on the prediction cumulative number of users;
referring to a work time table that includes an average work time in relation to a number of private stalls and utilization rate; and
setting, for each restroom, the average work time according to the number of private stalls and the utilization rate of the restroom.

11. The cleaning management device according to claim 1, wherein the processor is further configured to
refer to a database that stores satisfaction level data of a user for a cleaning state, and
calculate an integration score using a linear combination formula to which the prediction cumulative number of users of each restroom and a customer dissatisfaction level indicating indicates subjective evaluations from the users based on the satisfaction level data are input.

12. The cleaning management device according to claim 11, wherein the processor determines the cleaning timing at a time when the integration score reaches a predetermined threshold value.

13. The cleaning management device according to claim 1, wherein the processor is further configured to:
control, in response to the determined cleaning timing, a physical action that affects a state of the restroom, wherein the physical action comprises at least one of:
(i) causing a display board associated with a private stall in the restroom to display a message indicating that the private stall is unavailable for use, or
(ii) transmitting a signal to a cleaning management system to automatically dispatch a cleaning staff to the restroom.

14. The cleaning management device according to claim 1, wherein the work time table is a data structure stored in the at least one memory, the data structure comprising:
a first field representing a number of private stalls;
a second field representing a utilization rate of the restroom; and
a third field representing an average work time correlated to a combination of the number of private stalls and the utilization rate, wherein the processor performs a lookup operation against the data structure to retrieve the average work time for setting the cleaning duration.
